(19) United States
(12) Patent Application Publication
(10) Pub. No.: US 2016/0202191 A1
(43) Pub. Date: Jul. 14, 2016

(54) DEVICE FOR PRINT IMAGE OBSERVATION

(71) Applicant: Windmoeller & Hoelscher KG, Lengerich (DE)

(72) Inventor: Alois Thoele, Lienen (DE)

(73) Assignee: Windmoeller & Hoelscher KG, Lengerich (DE)

(21) Appl. No.: 14/912,935

(22) PCT Filed: Jul. 31, 2014
(86) PCT No.: PCT/EP2014/066455

§ 371 Date: Feb. 19, 2016

(30) Foreign Application Priority Data
Aug. 23, 2013 (DE) 10 2013 216 860.8
Jan. 24, 2014 (DE) 10 2014 201 309.7

(51) Int. Cl. G01N 21/892; G01J 5/02; B41F 33/00

(52) U.S. Cl. CPC G01N 21/892; B41F 33/00; G01J 5/02; G01J 2005/0077

(57) ABSTRACT

The invention relates to a device for observing a moving material web, in particular to observe a printed material web during the printing process, with a light source positioned on the front side of the material web to illuminate an observed section of the material web, with a camera positioned on the front side of the material web to record still images of the material web within the observed section, and with a light-diffusing surface positioned on the back side of the material web and within the observed section of the material web. In order to create a device for print image observation that can without exception detect color defects for any print job on an otherwise transparent material web, it is provided that the light-diffusing surface has elements to control the color of the light-diffusing surface.

The invention relates to a device for observing a moving material web, in particular to observe a printed material web during the printing process, with a light source positioned on the front side of the material web to illuminate an observed section of the material web, with a camera positioned on the front side of the material web to record still images of the material web within the observed section, and with a light-diffusing surface positioned on the back side of the material web and within the observed section of the material web.

Such a device is for instance known from EP 0 781 655 B1, which describes a device for print image observation, A light-diffusing surface is mounted behind the material web resp. the printed fabric, wherein the print image is observed with a video system. A diffusely reflecting surface in white or gray is recommended as the light-diffusing surface.

The problem on such a device is that color defects or color splatter on an otherwise transparent material web can then not be observed when said color splatter exactly matches the color of the diffusely reflecting surface.

The object of the invention is therefore to create a device for print image observation that can without exception detect the color defects for any print job on an otherwise transparent material web.

This task is solved by the characteristics of patent claim 1.

The device according to the invention to observe a moving material web comprises a light source positioned on the front side of the material web to illuminate an observed section of the material web, a camera positioned on the front side of the material web to record still images of the material web within the observed section, and a light-diffusing surface positioned on the back side of the material web and within the observed section of the material web, wherein the light-diffusing surface features elements to control the color of the light-diffusing surface.

This way, a background with the ideally matched color can be selected for each print job for color observation. It is conceivable that the color is selected automatically resp. computer-controlled as a function of the print image. Alternatively, it is, however, possible that the color is switched manually by the operator.

A significant advantage of the invention consists of the fact that the background color for print image observation can be switched on color-critical motifs. It would otherwise be necessary to install a second video system in front of a differently colored background, which would result in significantly higher costs compared to the solution according to the invention.

Pursuant to a preferred embodiment, a control unit is provided that analyzes the images created by the camera to control the quality of the material web.

Pursuant to a further preferred embodiment, it is provided that the light-diffusing, surface consists of a multi-colored continuous belt that is guided between two deflection rollers.

Pursuant to a further preferred embodiment, it is provided that the light-diffusing surface consists of a swiveling plate with two differently-colored sides.

Pursuant to a further preferred embodiment, it is provided that the light-diffusing surface is created by a colored fluid that can be filled into a transparent chamber.

Pursuant to a further preferred embodiment, it is provided that the light-diffusing surface consists of a thermal color coating whose color can change as a function of the temperature.

Pursuant to a further preferred embodiment, it is provided that the light-diffusing surface consists of a switchable LC glass and a colored surface positioned behind the former. Mectrochromic glass uses the characteristic of electrochromic materials to change the light transmittance as a function of the applied direct current. LC glass or PDLC glass (for liquid crystal resp. polymer dispersed liquid crystal) refers to glass rendered opaque at the push of a button. This process is reversible.

Further details and advantages of the invention are described based on the attached drawings. These show:

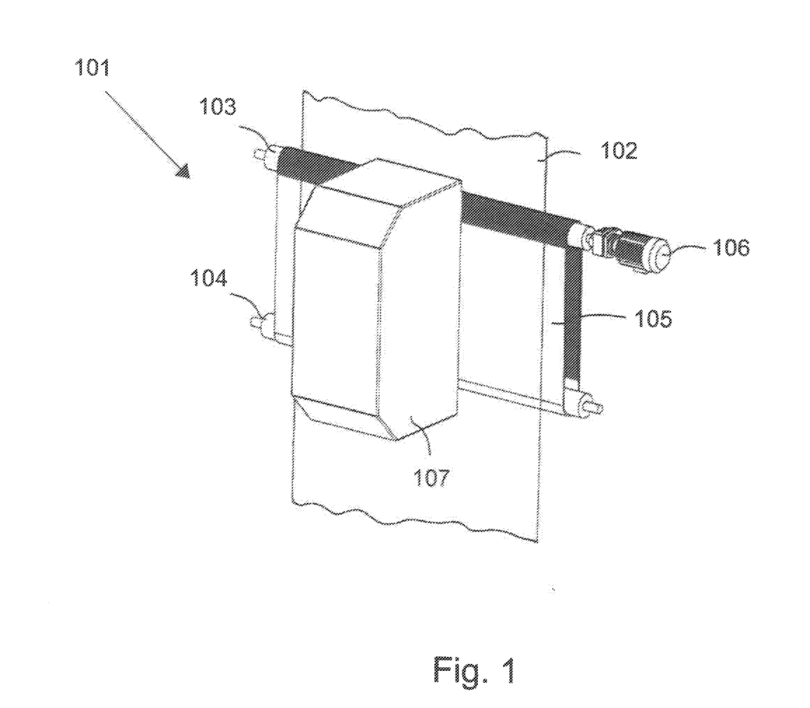

FIG. 1 a first exemplary embodiment of the invention,

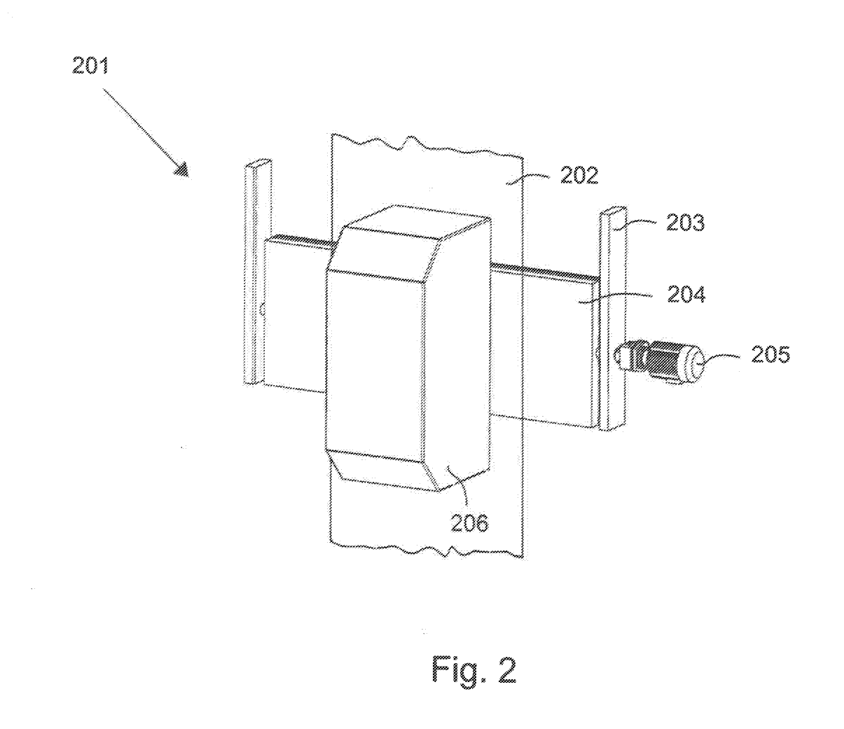

FIG. 2 a second exemplary embodiment of the invention,

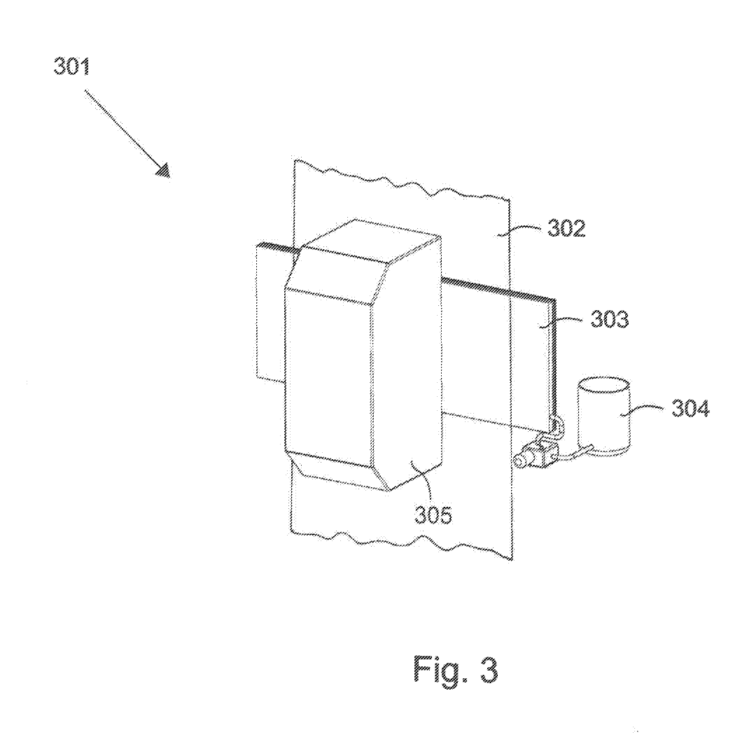

FIG. 3 a third exemplary embodiment of the invention,

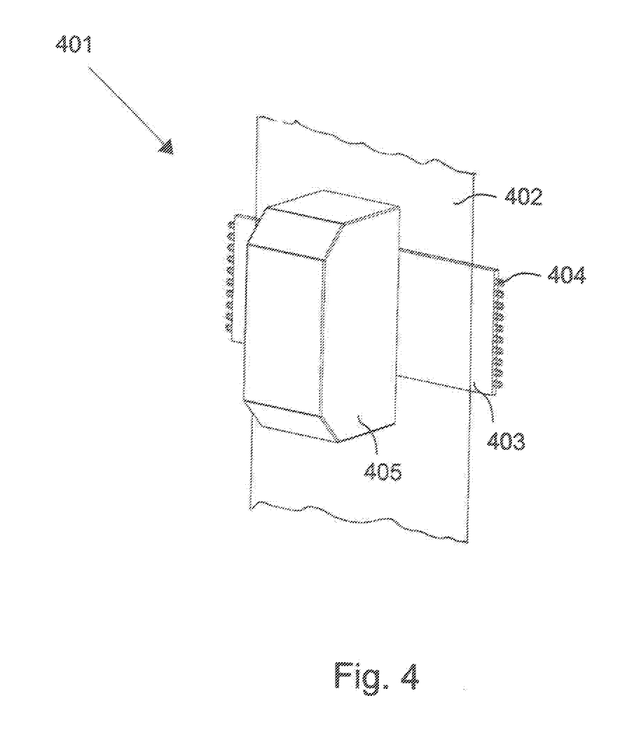

FIG. 4 a fourth exemplary embodiment of the invention, and

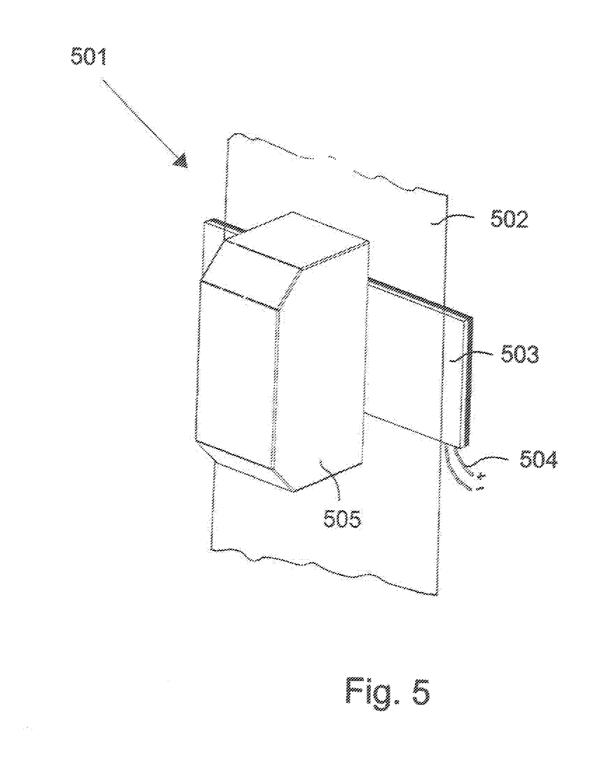

FIG. 5 a fifth exemplary embodiment of the invention,

FIG. 1 shows a first exemplary embodiment of the invention with a device 101 according to the invention to observe a moving material web 102. The device 101 is positioned within an observed section that is suited to inspect the quality of the printed material web 102.

Behind the material web 102, two deflection rollers 103 and 104 are positioned over which a continuous belt 105 is guided. The continuous belt 105 has a light-diffusing surface and features two or more sections with different colorations, so that the background color within the observed section can be changed with the drive 106. Alternatively, it is also conceivable that a manual drive, e.g. a hand wheel, is provided instead of the drive 106.

A camera 107 to record still images with a corresponding light source is positioned in front of the material web 102.

FIG. 2 shows a second exemplary embodiment of the invention with a device 201 according to the invention to observe a moving material web 202. The device 201 is positioned within an observed section that is suited to inspect the quality of the printed material web 202.

Behind the material web 202, a frame 203 is positioned in which a plate 204 is arranged on a horizontal, articulating axis. The plate 204 has two differently-colored sides, each with light-diffusing surfaces. The drive 205 and a not further shown swivel gear assembly can swivel the plate 204 around the horizontal axis, so that the background color within the observed section can be changed. Alternatively, it is also conceivable that a manual drive, e.g. a hand wheel, is provided instead of the drive 205.

A camera 206 to record still images with a corresponding light source is positioned in front of the material web 202.

FIG. 3 shows a third exemplary embodiment of the invention with a device 301 according to the invention to observe a moving material web 302. The device 301 is positioned within an observed section that is suited to inspect the quality of the printed material web 302.

Behind the material web 302, a transparent chamber 303 is positioned whose back side is colored with a first color (e.g. gray), so that the back side forms a light-diffusing surface facing the front side. Pump 304 can fill a fluid into chamber 303, wherein the fluid is colored with a second color (e.g. white). When the fluid has been filled, the fluid now forms the light-diffusing surface. By repeatedly draining or filling the chamber 303, the background color within the observed section can be changed in this manner.

A camera 305 to record still images with a corresponding light source is positioned in front of the material web 302.

FIG. 4 shows a fourth exemplary embodiment of the invention with a device 401 according to the invention to observe a moving material web 402. The device 401 is positioned within an observed section that is suited to inspect the quality of the printed material web 402.

A plate 403 is positioned behind the material web 402. The plate 403 features a light-diffusing surface with a thereto color coating. Peltier elements 404 are arranged within the plate, the former being electrically controllable so that the temperature of the plate and thus also the surface color can be changed by controlling the Peltier elements 404.

A camera 405 to record still images with a corresponding light source is positioned in front of the material web 402.

FIG. 5 shows a fifth exemplary embodiment of the invention with a device 501 according to the invention to observe a moving material web 502. The device 501 is positioned within an observed section that is suited to inspect the quality of the material web 502.

A plate 503 made from switchable LC glass or PDLC glass (for liquid crystal resp. polymer dispersed liquid crystal) is positioned behind the material web 502. The LC glass plate 503 as on its back side a coating with a light-diffusing surface in a first color (e.g. gray). By applying a current on connections 504, the LC glass plate 503 can be switched back and forth between the states “light-transmitting” and “not-light-transmitting.” In the not-light-transmitting state, the LC glass plate 503 is rendered in a second color (e.g. white), so that the background can be changed in total with a control on the connections 504.

A camera 505 to record still images with a corresponding light source is positioned in front of the material web 502.

Reference Label List

| | |
|---|---|
| 101 | Device |
| 102 | Material Web |
| 103 | Deflection Roller |
| 104 | Deflection Roller |
| 105 | Continuous Belt |
| 106 | Drive |
| 107 | Camera |
| 201 | Device |
| 202 | Material Web |
| 203 | Frame |
| 204 | Plate |
| 205 | Drive |
| 206 | Camera |
| 301 | Device |
| 302 | Material Web |
| 303 | Chamber |
| 304 | Pump |
| 305 | Camera |
| 401 | Device |
| 402 | Material Web |
| 403 | Plate |
| 404 | Peltier Element |
| 405 | Camera |
| 501 | Device |
| 502 | Material Web |
| 503 | Plate |
| 504 | Connections |
| 505 | Camera |

1. Device for observing a moving material web,
with a light source positioned on the front side of the material web to illuminate an observed section of the material web,
with a camera positioned on the front side of the material web to record still images of the material web within the observed section, and
a light-diffusing surface positioned on the back side of the material, web and within the observed section of the material web,
characterized in that
the light-diffusing surface has elements to control the color of the light-diffusing surface.

2. Device according to claim 1, characterized in that a control unit is provided that analyzes the images generated by the camera to control the quality of the material web.

3. Device according to claim 1, characterized in that the light-diffusing surface consists of a multi-colored continuous belt that is guided between two deflection rollers.

4. Device according to claim 1, characterized in that the light-diffusing surface consists of a swiveling plate with two differently colored sides.

5. Device according to claim 1, characterized in that the light-diffusing surface is created by a colored fluid that can be filled into to transparent chamber.

6. Device according to claim 1, characterized in that the light-diffusing surface consists of a thermo color coating whose color is changeable as a function of the temperature.

7. Device according to claim 1, characterized in that the light-diffusing surface consists of a switchable LC glass and a color surface located behind said LC glass.

8. Printing machine, in particular gravure printing machine, with a device for observing a moving material web pursuant to claim 1.
